(19) United States
(12) Patent Application Publication
(10) Pub. No.: US 2016/0060850 A1
(43) Pub. Date: Mar. 3, 2016

(54) FLUID STORAGE AND CIRCULATION SYSTEMS AND METHODS

(71) Applicant: Spero Systems, Inc., Scottsdale, AZ (US)

(72) Inventor: Joel Johnson, Mesa, AZ (US)

(21) Appl. No.: 14/842,616

(22) Filed: Sep. 1, 2015

Related U.S. Application Data
(60) Provisional application No. 62/044,811, filed on Sep. 2, 2014.
(60) Provisional application No. 62/105,205, filed on Jan. 20, 2015.

(51) Int. Cl. E03B 11/08; B67D 7/68; B67D 7/36

(52) U.S. Cl. CPC E03B 11/08; B67D 7/36; B67D 7/68

(57) ABSTRACT

The present disclosure provides fluid storage and circulation systems and methods. For example, a fluid system may comprise a tank, having a fluid inlet and a fluid outlet, a fluid intake line, in fluid communication with the fluid inlet, a fluid outlet line in fluid communication with the fluid outlet, the fluid outlet line having a first valve disposed thereon, an air release disposed on at least one of the tank, the fluid intake line, and the fluid outlet line, and a pump line in fluid communication with the fluid outlet line, the pump line having a first end, a second end, and a pump disposed therebetween.

### CROSS REFERENCE TO RELATED APPLICATIONS

This application is a non-provisional of U.S. provisional patent application Ser. No. 62/044,811, entitled “Self Rotating Water Storage,” filed on Sep. 2, 2014, and U.S. provisional patent application Ser. No. 62/105,205, entitled “Self Rotating Water Storage,” filed on Jan. 20, 2015, which are incorporated herein by reference.

### TECHNICAL FIELD

The present disclosure relates to fluid systems and methods and, more particularly, to water storage and circulation systems.

### BACKGROUND

Potable water is typically provided to the public through a pressurized fluid system. This pressurized fluid system communicates potable water to preexisting plumbing systems for delivery to users through hose bibs, spigots, faucets, and the like. However, during emergencies, routine maintenance, construction, or the like, pressurized fluid systems may not be able to provide a continuous potable water supply through preexisting plumbing systems. In one prior art solution, long-term storage of potable water in tanks or otherwise may result in water stagnation and contamination by microbes, chemicals, pollutants, or the like. Moreover long-term storage of potable water may be inconvenient for use because it is not provided through preexisting plumbing systems.

### SUMMARY

In general, the present disclosure provides fluid storage and circulation systems and methods. In various embodiments, a fluid system comprises a tank having a fluid inlet and a fluid outlet, a fluid intake line, and a fluid outlet line. In various embodiments, the fluid intake line is in fluid communication with the fluid inlet, and the fluid outlet line is in fluid communication with the fluid outlet. In various embodiments, the fluid system further comprises a first valve disposed on the fluid outlet line, an air release, a pump line in fluid communication with the fluid outlet line, and a pump.

In various embodiments, the present disclosure provides a multi-tank fluid system comprising a fluid intake line in fluid communication with a first tank, a second tank in fluid communication with a fluid outlet line, and an inter-tank line in fluid communication with both the first tank and the second tank. In various embodiments, the multi-tank fluid system further comprises a bypass line, a pump line having a pump disposed thereon, and a plurality of valves configured to control the communication of a fluid through the multi-tank fluid circuit.

In various embodiments, the present disclosure provides a method of using a fluid system comprising receiving a fluid from a pressurized fluid source, circulating a first portion of the fluid, storing a second portion of the fluid, providing the first portion of the fluid in response to the pressurized fluid source comprising a pressure above a predetermined threshold, and providing the second portion of the fluid in response to the pressurized fluid source comprising a pressure below the predetermined threshold.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain the principles of the disclosure.

FIG. 1 illustrates a block diagram of a fluid system in accordance with various embodiments;

FIG. 2 illustrates a schematic diagram of a fluid system in accordance with various embodiments;

FIG. 3 illustrates a schematic diagram of a multi-tank fluid system in accordance with various embodiments;

FIG. 4 illustrates a cross section view of yet another fluid system in accordance with various embodiments; and

FIG. 5 illustrates a perspective view of yet another fluid system in accordance with various embodiments.

### DETAILED DESCRIPTION

While the detailed description of various embodiments herein are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation.

For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

For example, in the context of the present disclosure, the device hereof may find particular use in connection with water storage and circulation systems, and the specific characteristics of each embodiment may be adapted to be optimized for performance and compatibility with preexisting plumbing systems such as, for example, public potable water supplies. However, generally speaking, numerous applications of the present disclosure may be realized for other purposes and in connection with fluids other than water.

In various embodiments, a fluid system may comprise one or more tanks and one or more fluid communication lines configured to communicate fluid to, through, and/or from the tank. The fluid system may be configured to receive fluid from a pressurized fluid source, such as a public potable water supply. The fluid system may be configured to provide fluid to a preexisting plumbing system, such as the potable water plumbing system of a residential, commercial, or public structure. In this way, in various embodiments, the fluid system may be retrofit onto the pressurized fluid source and/or the preexisting plumbing system. In various embodiments, the fluid system may be configured to optionally circulate fluid through the tank so as to minimize or decrease water stagnation and/or microbial growth. In various embodiments, the fluid system may be configured to optionally store fluid such that pressurized fluid may be continuously provided to the preexisting plumbing system, even when fluid is not available from the pressurized fluid source due to emergency, maintenance, or for any other reason.

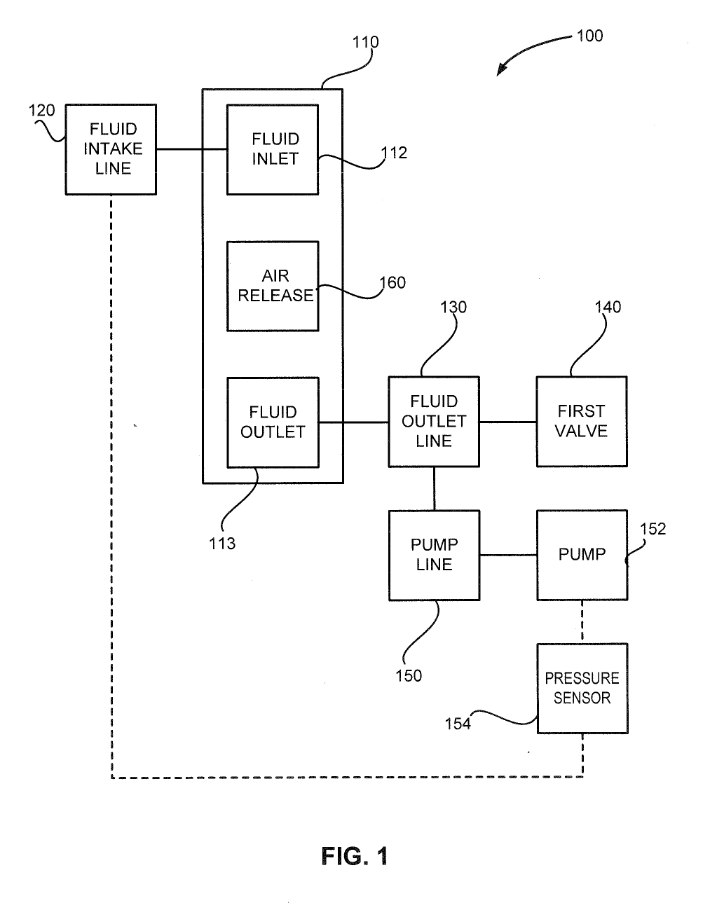

In various embodiments and with reference to FIG. 1, fluid system 100 may comprise a tank 110 having a fluid inlet 112 and a fluid outlet 113 thereon. Tank 110 may be in fluid communication with a fluid intake line 120 at fluid inlet 112. Tank 110 may be in fluid communication with a fluid outlet line 130 at fluid outlet 113. In various embodiments, fluid intake line 120 and/or fluid outlet line 130 may comprise a pipe, tube, channel, conduit, duct, hose, or the like.

In various embodiments, fluid system 100 may be configured to receive a fluid through the fluid intake line, store and/or circulate the fluid in the tank, and provide the fluid through the fluid outlet line. In various embodiments, fluid may be communicated into the tank through the fluid inlet and may be communicated out of the tank through the fluid outlet.

In various embodiments, the tank may fill from the bottom, as the fluid is communicated through a fluid inlet disposed in a bottom portion of the tank. In various embodiments, the tank may fill from the top, as the fluid is communicated through a fluid inlet disposed in a top portion of the tank. In various embodiments, the tank may empty as the fluid is communicated through a fluid outlet disposed in a bottom portion of the tank. In various embodiments, the tank may empty as the fluid is communicated through a fluid outlet disposed in a top portion of the tank. In yet other embodiments, the tank may be emptied and/or filled from any location between the top portion and the bottom portion of the tank.

In various embodiments, tank 110 may comprise a cylindrical shape. However, the tank may comprise any shape suitable for use in the fluid system including, without limitation, a conical shape, an elliptical shape, a prismatic shape, or the like. In various embodiments, tank 110 may define an interior volume 114 comprising about 189 liters (about 50 gallons) to about 7,570 liters (about 2000 gallons), wherein the term about means +/−5 liters (+/−1.32 gallons). However, in various embodiments, the interior volume may comprise any volume suitable for use in fluid system 100.

In various embodiments, tank 110 may be configured to withstand internal pressures of about 344.4 kilopascals (50 psi) to about 4136.9 kilopascals (about 600 psi), wherein the term about means +/−6.9 kilopascals (about 1 psi). In various embodiments, tank 110 may be configured to withstand internal pressures of about 689.5 kilopascals (about 100 psi), wherein the term about means +/−6.9 kilopascals (about 1 psi). However, in various embodiments, the tank may be configured to withstand any pressure suitable for use in the fluid system.

In various embodiments, the tank may comprise fiberglass, such as continuous strand fiberglass. However, in various embodiments, the tank may comprise a metal, alloy, composite or any other material suitable for use in the fluid system. In various embodiments, the tank may comprise a light blocking material. For example, in various embodiments, the tank 110 may comprise a material configured and/or coating to prevent or decrease transmission of ultraviolet light, visible light, and/or any other wavelength and/or frequency of light into the interior volume.

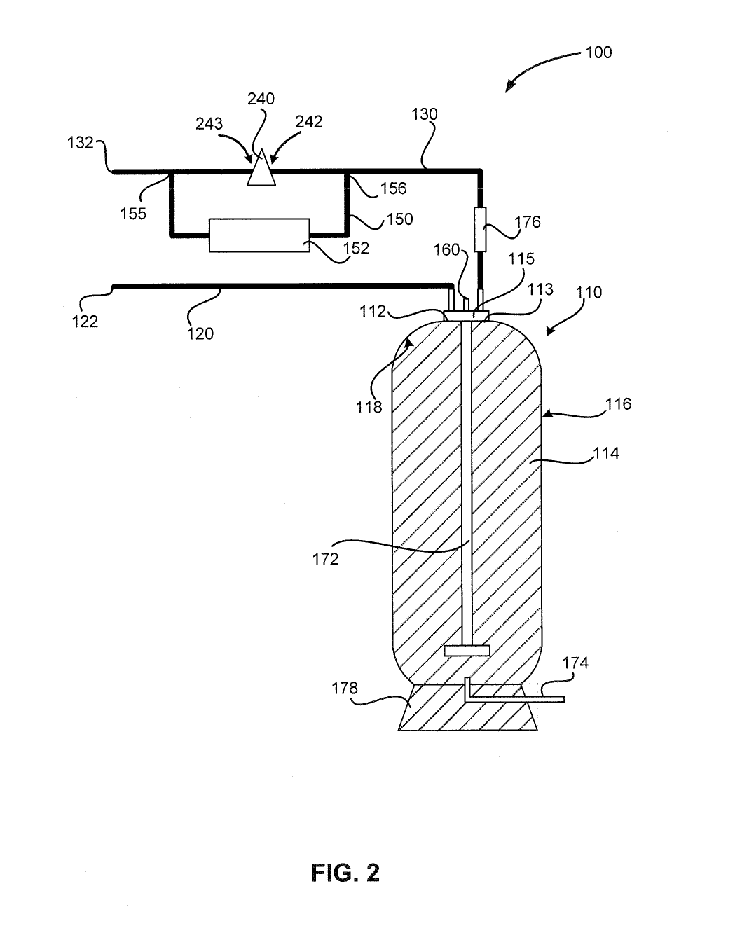

In various embodiments and with reference to FIG. 2, tank 110 may comprise a weather-resistant layer disposed on an exterior surface 116 of tank 110. In various embodiments, the weather-resistant layer may comprise an epoxy resin. However, in various embodiments, the weather-resistant layer may comprise any material suitable to decrease or minimize damage and/or wear to tank 110 resulting from exposure to environmental conditions such as heat, cold, wind, precipitation, or the like.

In various embodiments, tank 110 may comprise an inner layer disposed on an interior surface 118 of tank 110. In various embodiments, the inner layer may comprise a material free of bisphenol A. In various embodiments, the inner layer may comprise food grade polyethylene, low-density polyethylene, food grade polypropylene, and/or any other material suitable for contact with potable water. In various embodiments, the inner layer may decrease or minimize leaking of the fluid from tank 110 and/or direct physical contact between the fluid and tank 110.

In various embodiments, tank 110 may comprise an insulation layer disposed on an exterior surface 116 of tank 110 and/or on an interior surface 118 of tank 110. In various embodiments, the insulation layer may be configured to prevent or minimize heat transfer to and/or from the fluid disposed in tank 110.

In various embodiments and with reference now to FIGS. 1 and 2, tank 110 may comprise a fluid inlet 112 and a fluid outlet 113. Fluid inlet 112 and fluid outlet 113 may each define an aperture in exterior surface 116 and/or interior surface 118 of tank 110. In various embodiments, fluid inlet 112 may be configured to receive fluid from fluid intake line 120 and communicate it to interior volume 114 of tank 110. In various embodiments, fluid inlet 112 may be configured to receive fluid from interior volume 114 of tank 110 and communicate it to at least a portion of fluid intake line 120. Stated differently, in various embodiments, fluid inlet 112 may be configured for bi-directional fluid flow. In various embodiments, fluid outlet 113 may be configured to receive fluid from interior volume 114 of tank 110 and communicate it to at least a portion of fluid outlet line 130.

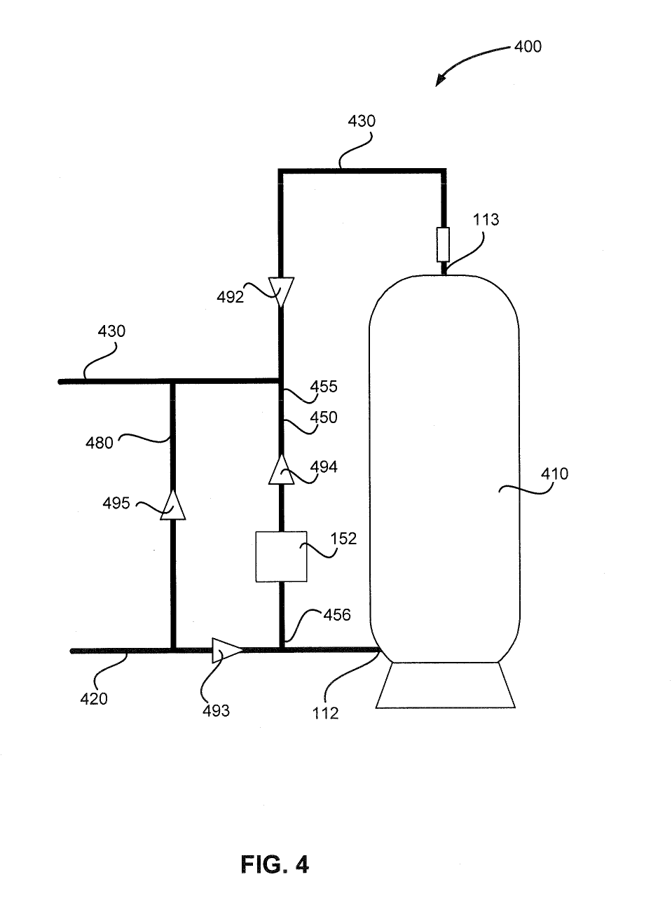

In various embodiments, fluid inlet 112 may comprise any shape and size compatible with a shape and size of fluid intake line 120 such that fluid system 100 comprises a substantially airtight seal therebetween, and fluid intake line 120 is in fluid communication with interior volume 114 of tank 110. In various embodiments, fluid outlet 113 may comprise any shape and size compatible with a shape and size of fluid outlet line 130 such that fluid system 100 comprises a substantially airtight seal therebetween, and fluid outlet line 130 is in fluid communication with interior volume 114 of tank 110. In various embodiments, fluid inlet 112 and fluid outlet 113 may be disposed on a top portion of tank 110. In various embodiments and with momentary reference to FIG. 4, fluid inlet 112 may be disposed on a bottom portion of tank 110 and fluid outlet 113 may be disposed on a top portion of tank 110. However, in various embodiments, fluid inlet 112 and fluid outlet 113 may be disposed on any suitable portion of tank 110.

In various embodiments and with reference again to FIGS. 1 and 2, fluid system 100 may be configured to communicate a fluid from upstream in the fluid intake line 120 to downstream in the fluid outlet line 130. As used herein, the term upstream should be understood to designate a relative location on the fluid system closer to a receiving end 122 of fluid intake line 120 distal from tank 110; the term downstream should be understood to designate a relative location on the fluid system closer to a providing end 132 of fluid outlet line 130 distal from tank 110. In various embodiments, receiving end 122 may be in fluid communication with a pressurized fluid source. In various embodiments, providing end 132 may be in fluid communication with a preexisting plumbing system. In various embodiments, providing end 132 may provide fluid to a user.

In various embodiments and with reference again to FIGS. 1 and 2, fluid system 100 may be configured to communicate a fluid comprising a first portion of fluid and a second portion of fluid. In various embodiments, the first portion and the second portion may comprise the same fluid. In various embodiments, fluid system 100 may be configured to store a second portion of the fluid in tank 110. In various embodiments, fluid system 100 may be configured to circulate the first portion of the fluid within tank 110 by communicating, in response to a command from a user, the fluid from a pressurized fluid source, through tank 110, and to a preexisting plumbing system.

In various embodiments, the pressurized fluid source may comprise a pressure greater than a predetermined threshold such that the pressure communicates the fluid downstream. In various embodiments, the predetermined threshold may comprise between about 34.5 kilopascals (about 5 psi) of fluid pressure to about 310.3 kilopascals (about 45 psi) of fluid pressure, wherein the term about means +/−6.9 kilopascals (about 1 psi). In various embodiments, the predetermined threshold may comprise about 172.4 kilopascals (about 25 psi) of fluid pressure, wherein the term about means +/−6.9 kilopascals (about 1 psi). However, in various embodiments, the predetermined threshold may comprise any suitable water pressure.

In various embodiments, in response to the pressurized fluid source comprising a pressure less than the predetermined threshold, fluid system 100 may be configured to communicate the fluid downstream. In such embodiments, fluid system 100 may comprise a pump line 150, with a pump 152 disposed thereon, in fluid communication with fluid outlet line 130.

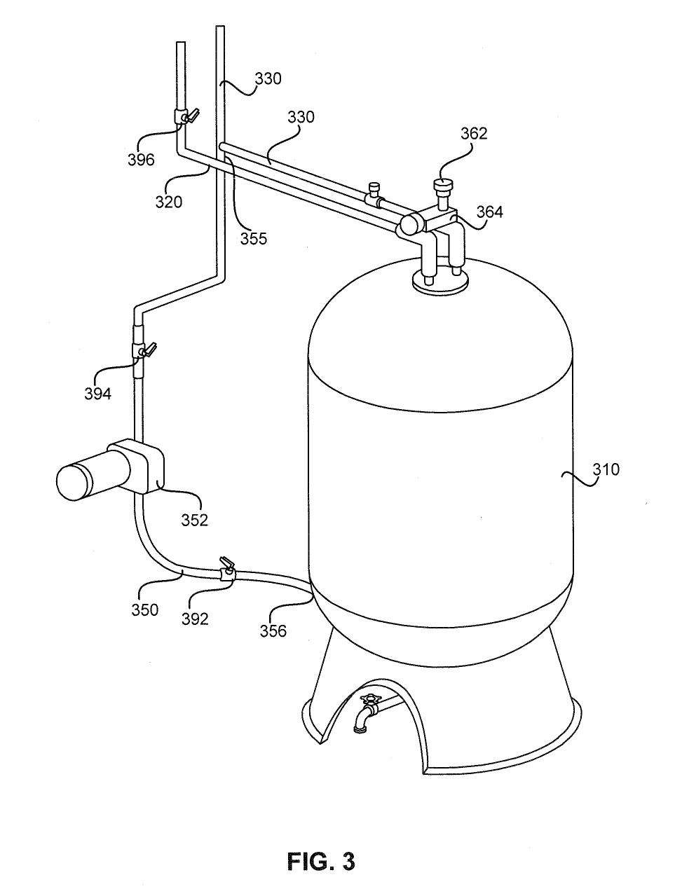

In various embodiments, the pump line may comprise a pipe, tube, channel, conduit, duct, hose, or the like. The pump line may comprise a first end and a second end, the first end being disposed upstream of the second end. In various embodiments, pump line 150 may comprise a first end 156 in fluid communication with fluid outlet line 130 and a second end 155 in fluid communication with fluid outlet line 130. However, in various embodiments and with momentary reference to FIG. 3, a pump line 350 may comprise a first end 356 in fluid communication with an interior volume of the tank 310 and a second end 355 in fluid communication with fluid outlet line 330.

In various embodiments, the pump 152 may be configured to generate pressure such that a second portion of the fluid is communicated from tank 110 downstream through fluid outlet line 130 in response to the pressurized fluid source comprising a pressure less than the predetermined threshold. In various embodiments, the pump may be disposed downstream of the tank. In such embodiments, the pump may be configured to pull the fluid from the tank and push the fluid downstream towards the preexisting plumbing system. In various embodiments, the pump may be disposed on the tank. In such embodiments, the pump may be configured to push and/or pull the fluid from the tank and push the fluid downstream towards the preexisting plumbing system. In various embodiments, the pump may be disposed upstream of the tank. In such embodiments, the pump may be configured to push the fluid into the tank and from the tank, downstream towards the preexisting plumbing system.

In various embodiments, the pump may be configured to generate about 275.8 kilopascals (about 40 psi) of water pressure to about 551.6 kilopascals (about 80 psi) of water pressure, wherein the term about means +/−6.9 kilopascals (about 1 psi). However, in various embodiments, the pump may be configured to generate any desired water pressure.

In various embodiments, pump 152 may be disposed on, and in fluid communication with, pump line 150 between first end 156 and second end 155. In various embodiments, pump 152 may comprise an on-demand pump. In various embodiments, pump 152 may comprise a self-priming pump. In various embodiments, pump 152 may comprise an electrical and/or electromechanical pump. In various embodiments, the pump may be activated by between about 12 volts and about 115 volts, allowing a user to power the fluid system through electrical connection to a typical wall outlet or to standard car battery. In various embodiments, pump 152 may comprise a mechanical and/or manual pump. However, in various embodiments, pump 152 may comprise any pump suitable for use in fluid system 100.

In various embodiments, pump 152 may comprise a pressure sensor 154 in communication with pump 152. In various embodiments, pressure sensor 154 may be integral to pump 152. In various embodiments, pressure sensor may be in electrical communication with pump 152 without being in direct physical contact with pump 152. For example, in various embodiments, pressure sensor 154 may be disposed on fluid intake line 120, fluid outlet line 130, or pump line 150, and may be disposed upstream or downstream of tank 110. In various embodiments, pressure sensor 154 may be configured to detect a pressure within fluid system 100.

In various embodiments, pressure sensor 154 may be configured to activate pump 152 in response to determining that a pressure is below a predetermined threshold. For example, in various embodiments, in response to detecting a pressure at or below about 172.4 kilopascals (about 25 psi), pressure sensor 154 may activate pump 152. For example, in various embodiments, in response to detecting a pressure between about 34.5 kilopascals (about 5 psi) of fluid pressure and about 310.3 kilopascals (about 45 psi) of fluid pressure, pressure sensor 154 may activate pump 152.

The fluid system may further comprise one or more valves. In various embodiments, the valve may comprise a manually controlled valve. In various embodiments, the valve may be operated by a controller. A controller may comprise a processor configured to implement various logical operations in response to execution of instructions, for example, instructions stored on a non-transitory, tangible, computer-readable medium. In various embodiments, the valve may be operated by a pressure sensor. In various embodiments, the valve may comprise a wired electrical connection with the controller. In various embodiments, the valve may comprise a wireless connection with the controller. For example, in various embodiments, the valve may be controlled by a remote, mobile device, and/or mobile device application.

In various embodiments and with reference to FIG. 1, fluid system 100 may comprise a first valve 140. First valve 140 may comprise a mechanical valve, such as a check valve or a ball valve, an electromechanical valve, such as a solenoid valve, or any type of valve suitable for use in fluid system 100. In various embodiments, and with reference to FIG. 2, fluid system 100 may comprise a check valve 240. In various embodiments, check valve 240 may be disposed on, and in fluid communication with, fluid outlet line 130 between first end 156 and second end 155. In various embodiments, check valve 240 may be configured such that a fluid may be communicated in only one direction from a first side 242 of check valve 240 to a second side 243 of check valve 240. In such embodiments, check valve 240 may allow communication of the fluid downstream through fluid outlet line 130, but may prevent communication of the fluid upstream through fluid outlet line 130, such as, for example, in response to pump 152 communicating fluid from tank 110 downstream through fluid outlet line 130 and/or pump line 150.

In various embodiments and with reference again to FIGS. 1 and 2, fluid system 100 may further comprise at least one air release. In various embodiments, air release 160 may be disposed on tank 110. In various embodiments, air release 160 may be in fluid communication with interior volume 114 of tank 110. In various embodiments and with reference to FIG. 3, an air release may comprise an air vent 362. Air vent 362 may be configured to communicate a gas and/or air from inside tank 310 externally from tank 310. In various embodiments, air vent 362 may comprise a filter, screen, or semi-permeable membrane configured to prevent or minimize communication of microbes and/or contaminants through air vent 362. In various embodiments, the air release may comprise a vacuum breaker 364. Vacuum breaker 364 may be configured to prevent or minimize communication of a fluid in an upstream direction from fluid outlet line 330 into tank 310. In various embodiments, the air release may be configured to manually exhaust gas and/or air from inside the tank. In such embodiments, the air release may be configured to decrease air pressure within the tank.

In various embodiments and with reference again to FIG. 2, fluid system 100 may further comprise at least one riser 172 disposed within tank 110 and in fluid communication with at least one of fluid inlet 112 and fluid outlet 113. In various embodiments, riser 172 may extend in a direction towards a bottom portion of tank 110. In various embodiments, riser 172 may comprise a pipe, tube, channel, conduit, duct, hose, or the like. In various embodiments, riser 172 may further comprise an end portion disposed at a bottom end of riser 172. In various embodiments, the end portion may extend from riser 172 at approximately a ninety-degree angle. In various embodiments, the end portion may extend in a substantially horizontal direction, radially outward from riser 172. However, the end portion may extend at any suitable angle and in any suitable direction. In various embodiments, the end portion may be configured to facilitate, and/or improve communication of fluid from the bottom portion of the tank into the riser.

In various embodiments, the riser may be configured to circulate the fluid within the tank. For example, in various embodiments, fluid may be communicated from the fluid intake line, through the riser, to a bottom portion of the tank, towards a top portion of the tank, and into the fluid outlet line. In various embodiments, fluid may be communicated from the fluid intake line into a top portion of the tank, towards a bottom portion of the tank, into and through the riser, and into the fluid outlet line. In various embodiments, the riser may be configured for bi-directional fluid communication.

In various embodiments, fluid system 100 may further comprise a tank head 115. In various embodiments, tank head 115 may be configured to adjustably control the communication of the fluid into, and/or out of, tank 110 and/or directly from fluid intake line 120 to fluid outlet line 130 without being communicated into interior volume 114. In various embodiments, tank head 115 may be in fluid communication with fluid intake line 120, fluid outlet line 130 and interior volume 114. In various embodiments, tank head 115 may be in fluid communication with at least one of fluid inlet 112 and fluid outlet 113. In various embodiments, tank head 115 may be in fluid communication with riser 172. In one embodiment, a first portion of the tank head may be configured to receive the fluid from the fluid intake line and to communicate the fluid into the interior volume, and a second portion of the tank head may be configured to receive the fluid from the riser and to communicate the fluid into the fluid outlet line. In such an embodiment, the first portion of the tank head may at least partially surround the second portion of the tank head.

In various embodiments, tank head 115 may further comprise a first tank head valve and a second tank head valve. In various embodiments, first tank head valve and/or second tank head valve may comprise a ball valve. However, in various embodiments, first tank head valve and/or second tank head valve may comprise any suitable type of valve. In various embodiments, first tank head valve may be in fluid communication with fluid intake line 120 and second tank head valve may be in fluid communication with fluid outlet line 130. In various embodiments, each of the first tank head valve and the second tank head valve may comprise a bypass position and a tank position. In response to each of the first tank head valve and the second tank head valve comprising the tank position, fluid system 100 may be configured to communicate fluid into, and out of, tank 110. In response to each of the first tank head valve and the second tank head valve comprising the bypass position, fluid system 100 may be configured to communicate fluid directly from directly from fluid intake line 120 to fluid outlet line 130, thereby bypassing tank 110.

In various embodiments, fluid system 100 may further comprise at least one spigot 174. In various embodiments, spigot 174 may be disposed on tank 110 and in fluid communication with interior volume 114 of tank 110. In various embodiments, spigot 174 may be configured so as to allow tank 110 to be drained for cleaning, maintenance, repair, use of the fluid, or any other desired purpose. In various embodiments, the spigot may be disposed on, and in fluid communication with, at least one of fluid intake line 120, fluid outlet line 130, and pump line 150. In various embodiments, spigot 174 may comprise a hose bib.

In various embodiments, fluid system 100 may further comprise flexible tubing 176 on at least a portion of at least one of fluid intake line 120, fluid outlet line 130, and pump line 150. In various embodiments, flexible tubing 176 may comprise stainless steel, copper, braided steel, cross-linked polyethylene, or any other material suitable for use in fluid system 100. In various embodiments, flexible tubing 176 may decrease or minimize vibration of at least one fluid communication line during use of fluid system 100.

In various embodiments, fluid system 100 may further comprise a tank stand 178. In various embodiments, tank stand 178 may be configured to receive tank 110 and may be disposed between tank 110 and the ground. In various embodiments, tank stand 178 may be configured to decrease or minimize movement of tank 110. In various embodiments, tank stand 178 may be configured to maintain tank 110 in an upright position.

In various embodiments, fluid system 100 may further comprise a backflow preventer. The backflow preventer may be configured to prevent or minimize communication of fluid upstream from the fluid system. In various embodiments, the backflow preventer may be disposed on the fluid intake line and/or upstream of the tank. However, the backflow preventer may be disposed on any suitable portion of the fluid system.

In various embodiments, a fluid system may further comprise at least one circuit valve. The circuit valve may be configured to enable maintenance of various portions of the fluid system without draining the fluid system. In various embodiments, the circuit valve may comprise a ball valve. However, the circuit valve may be any valve suitable for use as a circuit valve.

In various embodiments and with reference again to FIG. 3, a first circuit valve 392 may be disposed on, and in fluid communication with, pump line 350 downstream of a tank 310 and upstream of a pump 352. In various embodiments, a second circuit valve 394 may be disposed on, and in fluid communication with, pump line 350 downstream of pump 352. In various embodiments, first circuit valve 392 and/or second circuit valve 394 may be configured to allow maintenance, repair, or replacement of pump 352 without draining tank 310. In various embodiments, not draining tank 310 during maintenance, repair, or replacement of pump 352 enables continued communication of fluid from fluid intake line 320 through fluid outlet line 330.

In various embodiments, a third circuit valve 396 may be disposed on, and in fluid communication with, a fluid intake line 320. In various embodiments, the third circuit valve may be disposed upstream of other fluid system components. In various embodiments, third circuit valve 396 may be configured slow, minimize, and/or prevent flow of fluid into downstream components of the fluid system.

In various embodiments and with reference to FIG. 4, fluid system 400 may comprise a tank 410 in fluid communication with a fluid intake line 420, a fluid outlet line 430, and a pump line 450 as already described herein. In various embodiments, fluid system 400 may further comprise a bypass line 480 configured to communicate fluid directly from fluid intake line 420 to fluid outlet line 430. In such an embodiment, communication of the fluid through bypass line 480 may allow cleaning, maintenance, and/or repair of tank 410 and/or other components of fluid system 400. In various embodiments, bypass line 480 may be disposed on, and in fluid communication with, fluid intake line 420 upstream of a first end 456 of pump line 450, and may be disposed on, and in fluid communication with fluid outlet line 430 downstream of a second end 455 of pump line 450.

In various embodiments, fluid system 400 may comprise at least one valve. The at least one valve may comprise a mechanical valve, such as a check valve or a ball valve, an electromechanical valve, such as a solenoid valve, or any type of valve suitable for use in fluid system 400. In various embodiments, the at least one valve may comprise an open position and a closed position. In various embodiments, the open position may be configured to allow communication of a fluid through the at least one valve. In various embodiments, the closed position may be configured to prevent or minimize communication of a fluid through the at least one valve.

In various embodiments, fluid system 400 may comprise at least one of an outlet circulation valve 492, an intake circulation valve 493, a pump valve 494, and a bypass valve 495. In various embodiments, outlet circulation valve 492 may be disposed on, and in fluid communication with, fluid outlet line 430 downstream of tank 410. In various embodiments, intake circulation valve 493 may be disposed on, and in fluid communication with, fluid intake line 420 upstream of tank 410. In various embodiments, pump valve 494 may be disposed on, and in fluid communication with, pump line 450. In various embodiments, bypass valve 495 may be disposed on, and in fluid communication with, bypass line 480.

In various embodiments, fluid system 400 may comprise at least one of a circulation circuit, a pump circuit, and a bypass circuit. In various embodiments, the circulation circuit, the pump circuit, and/or the bypass circuit may be configured to communicate fluid along a pathway of the fluid system. Stated another way, fluid system 400 may be configured to controllably deliver fluid through a plurality of different pathways, which can be selected by a user. In an embodiment comprising a circulation circuit, in response to intake circulation valve 493 comprising the open position, outlet circulation valve 492 comprising the open position, pump valve 494 comprising the closed position, and bypass valve 495 comprising the closed position, the fluid may be communicated through the circulation circuit. In various embodiments, the circulation circuit communicates the fluid from fluid intake line 420, through tank 410, to outlet fluid line 430, without communicating the fluid completely through pump line 450 or bypass line 480.

In an embodiment comprising a pump circuit, in response to pump valve 494 comprising the open position, intake circulation valve 493 comprising the closed position, outlet circulation valve 492 comprising the closed position, and bypass valve 495 comprising the closed position, the fluid may be communicated through the pump circuit. In various embodiments, the pump circuit communicates the fluid from tank 410, through pump line 450, to outlet fluid line 430, without communicating the fluid completely through bypass line 480.

In an embodiment comprising a bypass circuit, in response to bypass valve 495 comprising the open position, pump valve 494 comprising the closed position, intake circulation valve 493 comprising the closed position, and outlet circulation valve 492 comprising the closed position, and the fluid may be communicated through the bypass circuit. In various embodiments, the bypass circuit communicates the fluid intake line 420, through bypass line 480, to fluid outlet line 430, without communicating the fluid completely through tank 410 or pump line 450.

In various embodiments, fluid system 400 may further comprise at least one of a pump, a pressure sensor, an air release, a spigot, a flexible tubing, a backflow preventer, and a tank stand, as already described herein.

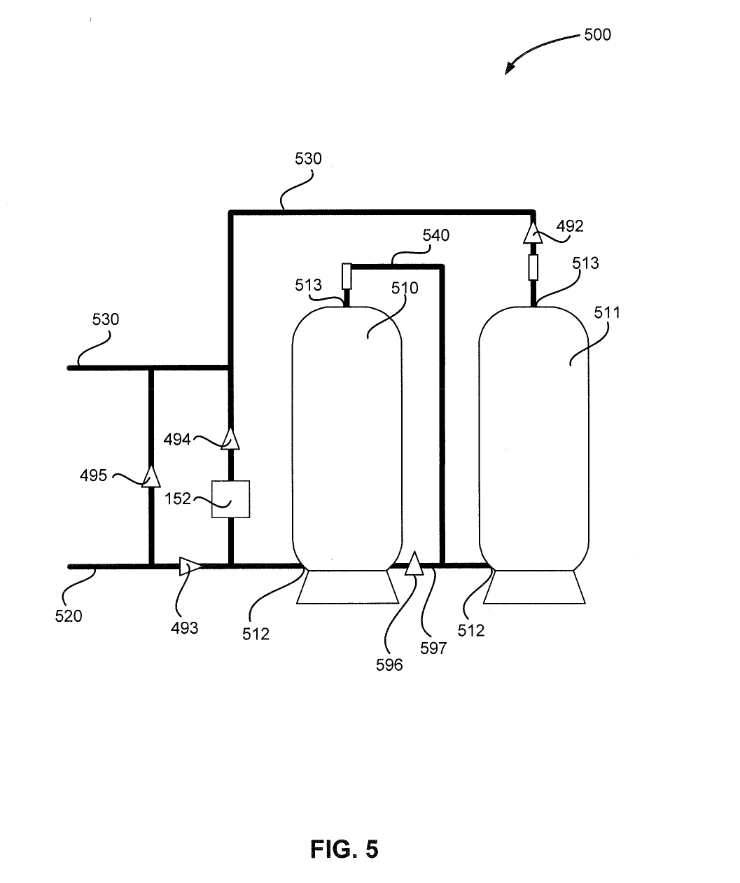

In various embodiments and with reference now to FIG. 5, multi-tank fluid system 500 may comprise at least a first tank 510 and a second tank 511. First tank 510 and second tank 511 may each comprise a fluid inlet 512 and a fluid outlet 513 as already described herein. In various embodiments, multi-tank fluid system may further comprise a fluid intake line 520 in fluid communication with the fluid inlet 512 of the first tank 510 and a fluid outlet line 530 in fluid communication with the fluid outlet 513 of the second tank 511.

In various embodiments, multi-tank fluid system 500 may further comprise an inter-tank line 540 disposed between and in fluid communication with first tank 510 and second tank 511. In various embodiments, inter-tank line 540 may be in fluid communication with a fluid outlet 513 of first tank 510 and with a fluid inlet 512 of second tank 511, such that a fluid may be communicated from fluid intake line 520, through first tank 510, through inter-tank line 540, through second tank 511, and to fluid outlet line 530.

In various embodiments, multi-tank fluid system 500 may further comprise at least one drain line 597 and at least one drain valve 596. In various embodiments, drain line 597 and drain valve 596 may be configured to drain first tank and/or second tank for maintenance purposes. In various embodiments, communication of fluid through drain line 597 and drain valve 596 may improve the energy efficiency and efficacy of a pump 152 as it communicates a fluid from the first tank and/or the second tank through fluid outlet line 530.

In various embodiments, drain line 597 may comprise a pipe, tube, channel, conduit, duct, hose, or the like. In various embodiments, drain line 597 may be in fluid communication with a bottom portion of first tank 510 and with a bottom portion of second tank 511. In various embodiments, drain line 597 may be in fluid communication with a bottom portion of first tank 510 and with inter-tank line 540. In various embodiments, drain line 597 may comprise substantially no vertical rise, such that the energy efficiency of communicating a fluid through drain line 597 is increased.

In various embodiments, drain valve 596 may comprise a mechanical valve, such as a check valve or a ball valve, an electromechanical valve, such as a solenoid valve, or any type of valve suitable for use in multi-tank fluid system 500. In various embodiments, drain valve 596 may comprise an open position and a closed position. In various embodiments, the open position may be configured to allow communication of a fluid through drain valve 596. In various embodiments, the closed position may be configured to prevent or minimize communication of the fluid through the drain valve 596. In various embodiments, in response to drain valve 596 comprising a closed position, the fluid may be circulated through first tank 510 and second tank 511 in series. In various embodiments, in response to drain valve 596 comprising an open position, first tank 510 and second tank 511 may be filled and/or drained without communicating the fluid through fluid outlet 513.

In various embodiments, the multi-tank fluid system may comprise a plurality of tanks, connected in series by a plurality of inter-tank lines, as already described herein. For example, in various embodiments, the multi-tank fluid system may comprise two tanks, three tanks, four tanks, five tanks, six tanks, or any suitable number of tanks.

In various embodiments, multi-tank fluid system 500 may further comprise a pump line 550 in fluid communication with the fluid outlet line, the pump line having a first end, a second end, and the pump 152 disposed therebetween. In various embodiments, multi-tank fluid system 500 may further comprise at least one of an outlet circulation valve 492, an intake circulation valve 493, a pump valve 494, and a bypass valve 495, as already described herein. In various embodiments, multi-tank fluid system 500 may be configured to communicate a fluid through at least one of a circulation circuit, a pump circuit, and a bypass circuit, as already described herein. In various embodiments, multi-tank fluid system 500 may further comprise at least one of a pressure sensor, an air release, a spigot, a flexible tubing, a backflow preventer, and a tank stand, as already described herein.

In various embodiments, a method of using a fluid system may comprise receiving a fluid from a pressurized fluid source, circulating a first portion of the fluid through the fluid system, and storing a second portion of the fluid in a tank. In various embodiments, the method may further comprise providing the first portion of the fluid in response to the pressurized fluid source comprising a pressure above a predetermined threshold. In various embodiments, the method may further comprise providing the second portion of the fluid in response to the pressurized fluid source comprising a pressure below the predetermined threshold.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Devices and methods are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A fluid system comprising:
a tank comprising a fluid inlet and a fluid outlet;
a fluid intake line in fluid communication with the fluid inlet;
a fluid outlet line in fluid communication with the fluid outlet, the fluid outlet line having a first valve disposed thereon;
an air release disposed on at least one of the tank, the fluid intake line, and the fluid outlet line; and
a pump line in fluid communication with the fluid outlet line, the pump line having a first end, a second end, and a pump disposed therebetween.

2. The fluid system of claim 1, wherein:
the first end is in fluid communication with the fluid outlet line;
the second end is in fluid communication with the fluid outlet line; and
the first valve comprises a check valve disposed upstream of the second end.

3. The fluid system of claim 1, wherein:
the first end is in fluid communication with an interior volume of the tank;
the second end is in fluid communication with the fluid outlet line; and
the first valve comprises a check valve disposed upstream of the second end.

4. The fluid system of claim 2, further comprising a pressure sensor in communication with the pump.

5. The fluid system of claim 2, further comprising a riser disposed within the tank, extending in a direction toward a bottom portion of the tank, and in fluid communication with the fluid outlet.

6. The fluid system of claim 2, further comprising at least one spigot disposed on a bottom portion of the tank.

7. The fluid system of claim 2, wherein at least a portion of at least one of the fluid intake line, the fluid outlet line, and the pump line comprises flexible tubing.

8. The fluid system of claim 1, further comprising:
a bypass line disposed between, and in fluid communication with, the fluid intake line and the fluid outlet line;
wherein the first end is in fluid communication with the fluid intake line and disposed downstream of the bypass line and upstream of the tank; and
wherein the second end is in fluid communication with the fluid outlet line and disposed downstream of the tank and upstream of the bypass line.

9. The fluid system of claim 8, further comprising:
a bypass valve disposed on the bypass line;
a pump valve disposed on the pump line; and
an intake circulation valve disposed on the fluid intake line downstream of the bypass line and upstream of the pump line;
wherein the first valve comprises an outlet circulation line disposed downstream of the tank and upstream of the pump line.

10. The fluid system of claim 9, further comprising a pressure sensor in communication with the pump.

11. The fluid system of claim 9, further comprising a riser disposed within the tank, extending in a direction toward a bottom portion of the tank, and in fluid communication with the fluid outlet.

12. The fluid system of claim 9, further comprising at least one spigot disposed on a bottom portion of the tank.

13. The fluid system of claim 9, wherein at least a portion of at least one of the fluid intake line, the fluid outlet line, the bypass line, and the pump line comprises flexible tubing.

14. A multi-tank fluid system comprising:
a first tank comprising a fluid inlet and a fluid outlet;
a second tank comprising a fluid inlet and a fluid outlet;
a fluid intake line in fluid communication with the fluid inlet of the first tank;
at least one inter-tank line in fluid communication with the first tank and the second tank;
a fluid outlet line in fluid communication with the fluid outlet of the second tank, the fluid outlet line having a valve disposed thereon;
an air release disposed on at least one of the first tank, the second tank, the inter-tank line, and the fluid outlet line; and
a pump line in fluid communication with the fluid outlet line, the pump line having a first end, a second end, and a pump disposed therebetween.

15. The multi-tank fluid system of claim 14, wherein:
the first end is in fluid communication with the fluid outlet line;
the second end is in fluid communication with the fluid outlet line; and
the first valve comprises a check valve disposed upstream of the second end.

16. The multi-tank fluid system of claim 14, further comprising:
a bypass line disposed between, and in fluid communication with, the fluid intake line and the fluid outlet line;
wherein the first end is in fluid communication with the fluid intake line and disposed downstream of the bypass line and upstream of the first tank; and
wherein the second end is in fluid communication with the fluid outlet line and disposed downstream of the second tank and upstream of the bypass line.

17. The multi-tank fluid system of claim 16, further comprising:
a bypass valve disposed on the bypass line;
a pump valve disposed on the pump line; and
an intake circulation valve disposed on the fluid intake line downstream of the bypass line and upstream of the pump line;
wherein the first valve comprises an outlet circulation line disposed downstream of the second tank and upstream of the pump line.

18. A method of using a fluid system comprising:
receiving a fluid from a pressurized fluid source;
circulating a first portion of the fluid;
storing a second portion of the fluid;
providing the first portion of the fluid in response to the pressurized fluid source comprising a pressure above a predetermined threshold;
providing the second portion of the fluid in response to the pressurized fluid source comprising a pressure below the predetermined threshold.

19. The method of claim 18, wherein the fluid system comprises:
a tank comprising a fluid inlet and a fluid outlet;
a fluid intake line in fluid communication with the fluid inlet;
a fluid outlet line in fluid communication with the fluid outlet, the fluid outlet line having a first valve disposed thereon;
an air release disposed on at least one of the tank, the fluid intake line, and the fluid outlet line; and
a pump line in fluid communication with the fluid outlet line, the pump line having a first end, a second end, and a pump disposed therebetween.

20. The method of claim 18, wherein the fluid system comprises a multi-tank fluid system.
